(19) United States
(12) Patent Application Publication
(10) Pub. No.: US 2022/0012804 A1
(43) Pub. Date: Jan. 13, 2022

(54) BLOCKCHAIN-BASED INFORMATION INTERACTION METHOD, BLOCKCHAIN NODE AND CREDIT INVESTIGATION SYSTEM

(71) Applicants: BEIJING JINGDONG SHANGKE INFORMATION TECHNOLOGY CO, LTD., Beijing (CN); BEIJING JINGDONG CENTURY TRADING CO.,LTD., Beijing (CN)

(72) Inventor: Mingsen LUO, Beijing (CN)

(73) Assignees: BEIJING JINGDONG SHANGKE INFORMATION TECHNOLOGY CO, LTD., Beijing (CN); BEIJING JINGDONG CENTURY TRADING CO.,LTD., Beijing (CN)

(21) Appl. No.: 17/294,087

(22) PCT Filed: Jan. 9, 2020
(86) PCT No.: PCT/CN2020/071202

§ 371 Date: May 14, 2021

(30) Foreign Application Priority Data
Jan. 31, 2019 (CN) 201910097554.0

(51) Int. Cl. G06Q 40/02; G06Q 50/26; G06Q 50/00; G06Q 30/02; H04L 9/32; G06F 21/62

(52) U.S. Cl. CPC G06Q 40/025; G06Q 50/26; G06Q 50/01; H04L 2209/38; H04L 9/3239; G06F 21/6245; G06Q 2220/10; G06Q 30/0201

(57) ABSTRACT

A blockchain-based information interaction method, a blockchain node, and a credit investigation network. A blockchain-based information interaction method includes generating, by a blockchain node, a credit information summary according to user data; generating blockchain information according to the credit information summary; and distributing the blockchain information on a blockchain network, so as to perform interaction of user credit information summary from different nodes through the blockchain network.

### CROSS-REFERENCE TO RELATED APPLICATIONS

This application is based on and claims the priority to the Chinese Patent Application No. 201910097554.0, filed on Jan. 31, 2019, the disclosure of which is incorporated by reference in its entirety into the present application.

### TECHNICAL FIELD

This disclosure relates to the technical field of blockchain, and particularly to a blockchain-based information interaction method, a blockchain node and a credit investigation system.

### BACKGROUND

At present, personal credit information is mainly collected and processed by personal credit agencies, and then inquiry and evaluation services of the personal credit information are provided according to user's specific requirements. Personal information collected by the credit agencies mainly includes bank statements, payroll certificates, credit card information and loan information, etc.

In addition, each enterprise also generates its own user credit service according to its own stored user information, and a user can realize bicycle sharing, car sharing without deposit, etc., by means of his or her credit rating in the enterprise.

### SUMMARY

According to an aspect of some embodiments of the present disclosure, there is provided a blockchain-based information interaction method, comprising: generating, by a blockchain node, a credit information summary according to user data; generating blockchain information according to the credit information summary; and distributing the blockchain information on a blockchain network, to perform user interaction of credit information summary from different nodes through the blockchain network

In some embodiments, generating, by a blockchain node, a credit information summary according to user data comprises: generating the credit information summary according to at least one of user's assets, social relations and payment records recorded by a government agency; generating the credit information summary according to at least one of user's income, statements, properties, or loan records recorded by a bank; or generating the credit information summary according to user's behavior records on an enterprise platform

In some embodiments, the generating the credit information summary according to user's behavior records on an enterprise platform comprises: generating the credit information summary according to one or more of user's chat records on a social software, transaction records on a payment platform, consumption records on a shopping platform, or travel records on a travel or map platform.

In some embodiments, the information interaction method further comprises: receiving a data inquiry request; and generating the blockchain information according to the data inquiry request and distributing the blockchain information on the blockchain network, to generate the credit information summary by each blockchain node according to the data inquiry request.

In some embodiments, the information interaction method further comprises: in the case that a data inquiry request is comprised in received blockchain information, or the data inquiry request is received from an inquirer, inquiring stored user data according to inquiry requirements in the data inquiry request, then generating the credit information summary, and generating the blockchain information and distributing to the blockchain network, wherein the blockchain information comprising the data inquiry request is generated and distributed to the blockchain network by a blockchain node receiving the data inquiry request from the inquirer.

In some embodiments, the information interaction method further comprises: determining an encryption key according to a read permission level of the credit information summary; and generating encrypted blockchain information according to the credit information summary and the encryption key, to allow a blockchain node that meets the read permission level requirement to resolve the encrypted blockchain information and prevent a blockchain node that does not meet the read permission level requirement from resolving the encrypted blockchain information.

In some embodiments, the information interaction method further comprises: storing received blockchain information, and decrypting the received blockchain information by using a decryption key, wherein the received blockchain information is generated by encryption with the use of the encryption key determined according to the read permission level of the credit information summary; and in the case the decryption is successful, extracting the credit information summary and feeding back to an inquirer; and in the case that the decryption fails, feeding inadequate permission back to the inquirer.

According to an aspect of other embodiments of the present disclosure, there is provided a blockchain node, comprising: a summary generation unit, configured to generate a credit information summary according to user data; a blockchain information generation unit, configured to generate blockchain information according to the credit information summary; and a blockchain information interaction unit, configured to distribute the blockchain information on a blockchain network, and receive blockchain information from the blockchain network, to perform the interaction of credit information summary from different nodes through the blockchain network.

In some embodiments, the summary generation unit is configured to: generate the credit information summary according to at least one of user's assets, social relations and payment records recorded by a government agency; generate the credit information summary according to at least one of user's income, statements, properties, or loan records recorded by a bank; or generate the credit information summary according to user's behavior records on an enterprise platform.

In some embodiments, that generating the credit information summary according to user's behavior records on an enterprise platform comprises: generating the credit information summary according to one or more of user's chat records on a social software, transaction records on a payment platform, consumption records on a shopping platform, or travel records on a travel or map platform.

In some embodiments, the blockchain node further comprises: a request receiving unit, configured to receive a data inquiry request; the blockchain information generation unit, further configured to generate the blockchain information according to the data inquiry request, to distribute the blockchain information by the blockchain information interaction unit to the blockchain network, and to generate the credit information summary by each blockchain node according to the data inquiry request.

In some embodiments, the summary generation unit is further configured to: in the case that a data inquiry request is comprised in the blockchain information received by the blockchain information interaction unit, or the data inquiry request is received from an inquirer by the blockchain node, inquire stored user data according to inquiry requirements in the data inquiry request, and generate the credit information summary, to distribute blockchain information to the blockchain network by the blockchain information interaction unit after the blockchain information is generated by the blockchain information generation unit, wherein the blockchain information comprising the data inquiry request is generated and distributed to the blockchain network by a blockchain node receiving the data inquiry request from the inquirer.

In some embodiments, the blockchain node further comprises: a key determination unit, configured to determine an encryption key according to a read permission level of the credit information summary; the blockchain information generation unit, configured to generate encrypted blockchain information according to the credit information summary and the encryption key, to allow a blockchain node that meets the read permission level to resolve the encrypted blockchain information and to prevent a blockchain node that does not meet the read permission level from resolving the encrypted blockchain information.

In some embodiments, the blockchain node further comprises: a decryption unit, configured to decrypt received blockchain information by using a decryption key, wherein the received blockchain information is generated by encryption with the use of the encryption key determined according to the read permission level of the credit information summary; and a feedback unit, configured to extract the credit information summary and feed back to an inquirer in the case that the decryption unit succeeds in the decryption; and to feed inadequate permission back to the inquirer in the case that the decryption unit fails in the decryption.

According to an aspect of still other embodiments of the present disclosure, there is provided a blockchain node, comprising: a memory; and a processor coupled to the memory, wherein the processor is configured to perform any of the above blockchain-based information interaction methods based on instructions stored in the memory.

According to an aspect of further embodiments of the present disclosure, there is provided a computer-readable storage medium having stored thereon computer program instructions, which when executed by a processor, implement steps of any of the above blockchain-based information interaction methods.

In addition, according to an aspect of some embodiments of the present disclosure, there is provided a credit investigation system, comprising: a plurality of the blockchain nodes according to any of the above items; and a network link, configured to act as an carrier for carrying interaction between the blockchain nodes.

In some embodiments, the blockchain node comprises at least one of: a government agency blockchain node, configured to generate the credit information summary according to at least one of user's assets, social relations and payment records recorded by a government agency; a bank blockchain node, configured to generate the credit information summary based on at least one of user's income, statements, properties, or loan records recorded by a bank; or an enterprise blockchain node, configured to generate the credit information summary according to user's behavior records on an enterprise platform.

### BRIEF DESCRIPTION OF THE DRAWINGS

The accompanying drawings described herein are provided for a further understanding of the present disclosure and constitute a part of this disclosure, and the illustrative embodiments of the present disclosure together with the descriptions thereof, serve to explain the present disclosure and not to improperly limit the present disclosure. In the drawings:

FIG. 1 is a flow diagram of a blockchain-based information interaction method according to some embodiments of the present disclosure.

FIG. 2 is a flow diagram of dealing with a data inquiry request in the blockchain-based information interaction method according to some embodiments of the present disclosure.

FIG. 3 is a flow diagram of a portion of a blockchain-based information interaction method according to some other embodiments of the present disclosure.

FIG. 4 is a schematic diagram of a blockchain node according to some embodiments of the present disclosure.

FIG. 5 is a schematic diagram of a blockchain node according to some other embodiments of the present disclosure.

FIG. 6 is a schematic diagram of a blockchain node according to still other embodiments of the present disclosure.

FIG. 7 is a schematic diagram of a credit investigation system according to some embodiments of the present disclosure.

### DETAILED DESCRIPTION

The technical solution of the present disclosure is further described in detail by means of the accompanying drawings and the embodiments.

The inventors found that at present, part of personal credit information is stored by the government, and state-owned banks such as the People's Bank of China, and another part thereof is stored in respective private databases by private enterprises such as Tencent, Alibaba, JD, so that this information is relatively independent and not comprehensive. However, in many fields, such as commercial credit sales, credit transactions and recruitments, there is a great need for comprehensive personal credit information. One objective of the present disclosure is to improve the comprehensiveness of the personal credit information.

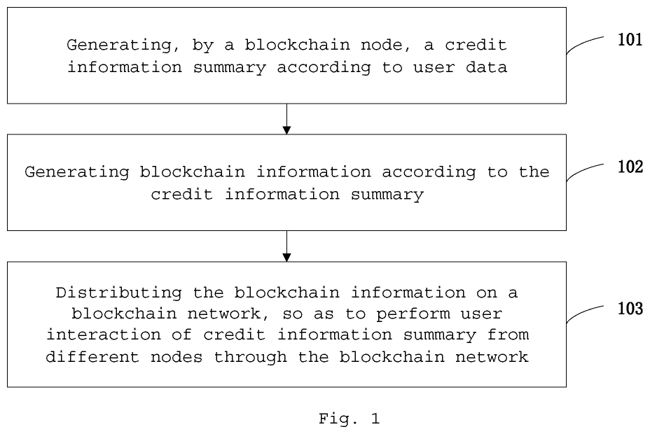

A flow diagram of a blockchain-based information interaction method according to some embodiments of the present disclosure is shown in FIG. 1.

In step 101, a blockchain node generates a credit information summary according to user data. In some embodiments, the blockchain node can be a blockchain node of each government agency, capable of acquiring user data stored by the corresponding government agency; the blockchain node can be a blockchain node of each bank, capable of acquiring user data stored by the corresponding bank; and the blockchain node can also be a blockchain node of each enterprise, capable of acquiring blockchain data stored by the corresponding enterprise. The blockchain node generates the credit information summary according to its own acquired user information.

In step 102, blockchain information is generated according to the credit information summary.

In step 103, the blockchain information is distributed on a blockchain network, and blockchain information from other nodes of the blockchain network is received, so as to perform the interaction of credit information summary from different nodes through the blockchain network.

By such a method, a blockchain node can generate the credit information summary according to user data that can be acquired, and distribute it as the blockchain information on a blockchain network; and can receive the blockchain information from other blockchain nodes, thereby implementing user credit information interaction among different government agencies, different banks, different enterprises and among the government agencies, banks and enterprises based on the blockchain network, which improves the comprehensiveness of the personal credit information obtained from each node.

A blockchain network system can be composed of a data layer, a network layer, a consensus layer, an incentive layer, a contract layer and an application layer. The data layer encapsulates a bottom data block, and related basic data and algorithms such as data encryption and time stamps; the network layer comprises a distributed networking mechanism, a data propagation mechanism, and a data verification mechanism, etc.; the consensus layer mainly encapsulates various consensus algorithms of network nodes; the incentive layer integrates economic factors into a blockchain technology system and mainly comprises an issuance mechanism and a distribution mechanism of economic incentives, etc.; the contract layer mainly encapsulates various scripts, algorithms and intelligent contracts, and is the basis of the programmable characteristic of the blockchain; the application layer encapsulates application scenarios and cases of the blockchain.

At present, banks have mastered information such as personal income, personal bank statements, partial personal properties, government departments have mastered personal fixed asset information, e.g.: houses, vehicles, personal social insurance payment information, family member information and the like, while each enterprise has mastered part of internet surfing information of users according to different business projects, such as chatting information generated in social software and chatting software, daily transaction information and shopping information generated in payment transaction software, daily consumption information generated in shopping software and daily travel information generated in travel software. The above types of information cover more comprehensive personal data, and personal credit data comprehensively generated by these data is more objective and complete. However, at present, the information held by each institution cannot be shared, and even if the information can be shared, the information is updated slowly, so that information of all parties cannot be integrated in time to generate complete personal credit information.

In the manner according to the embodiment of the present disclosure, the fast calling of the user credit data in each agency, enterprise and bank can be realized at any node, which improves the efficiency of updating the credit information, and also facilitates applications in various occasions, including bicycle or car sharing without deposit, job hunter evaluation and the like.

In some embodiments, because part of user data has certain privacy, and for a data holder, part of user data belongs to business secrets, when the blockchain node generates the credit information summary according to the user data, the blockchain node can retain the original data, and generate the credit information summary which can reflect user credit status according to the original user data, or only provide user credit evaluation (credit scores for users by enterprises and institutions such as Sesame Credit and Koala Credit), so that not only the integrity of the personal credit data is ensured, but also the damage to interests of each participant is avoided; and each blockchain node can acquire data of other nodes, without fear of leaking its own core data secrets.

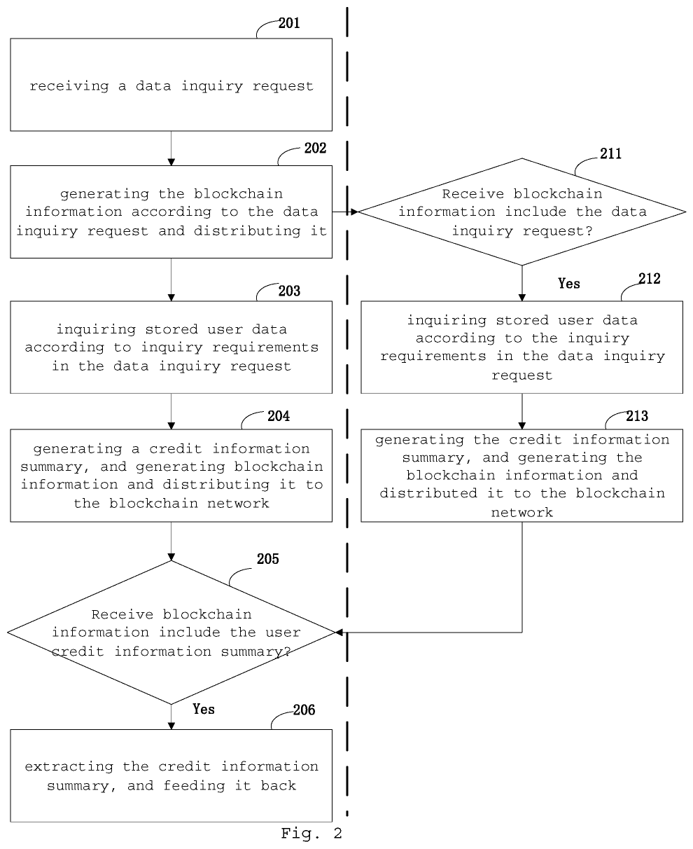

A flow diagram of dealing with a data inquiry request in the blockchain-based information interaction method according to some embodiments of the present disclosure is shown in FIG. 2, where in a single interaction, steps on the left and right sides of a dotted line are executed by different blockchain nodes, respectively.

In step 201, a blockchain node receives a data inquiry request from a data inquirer. In some embodiments, the data inquiry request can be initiated by the inquirer to a corresponding blockchain node through a data inquiry channel and node associated with any blockchain node, e.g., sending the data inquiry request to a blockchain node of a bank through an inquiry channel of a bank, or sending the data inquiry request to an blockchain node of an enterprise A through a data inquiry channel or node of an enterprise A, etc. In some embodiments, the data inquiry request can include a name, identification number of the inquired user, or other information that facilitates identifying this user. In other embodiments, the data inquiry request can include a user filtering requirement, such as a requirement for one or more credits, so as to filter out a user meeting this requirement.

In step 202, the blockchain node receiving the data inquiry request from the inquirer generates the blockchain information according to the data inquiry request and distributes it to a blockchain network, such that each node in the blockchain network can receive the data inquiry request, so that it is convenient for each node to store the user credit information summary, and is also convenient to record all data and data requests in the form of blockchain data, and to store them in each node, which ensures that the data request record is not falsified and is traceable.

In step 203, the blockchain node receiving the data inquiry request from the inquirer inquires stored user data according to inquiry requirements in the data inquiry request.

In step 204, the blockchain node receiving the data inquiry request from the inquirer generates the credit information summary, and then performs step 206. In some embodiments, the blockchain node can directly feed the generated credit information summary back to the inquirer; in other embodiments, the blockchain node can also generate the blockchain information according to the generated credit information summary, and distribute it to the blockchain network, so as to form information sharing with other nodes in the network, which facilitates the inquirer to inquiry the same information from other nodes.

In step 211, after receiving blockchain information, each blockchain node in the blockchain network determines whether the blockchain information includes the data inquiry request. In the case that it is determined that the data inquiry request is included, step 212 is performed.

In step 212, the blockchain node inquires the stored user data according to the inquiry requirements in the data inquiry request.

In step 213, the credit information summary is generated based on the stored user data, and the blockchain information is generated and distributed to the blockchain network, and then step 205 is performed.

In step 205, the blockchain node issuing the data inquiry request determines whether the received blockchain information includes the user credit information summary. If it is determined that the blockchain information includes the user credit information summary, step 206 is performed; otherwise, the blockchain information is stored.

In step 206, the blockchain node extracts the credit information summary from the blockchain information, and feeds the user credit information back to the inquirer. In some embodiments, the blockchain node can wait for a predetermined time period and feed the credit information summaries in multiple pieces of the received blockchain information back to the inquirer together or one by one, thereby facilitating the user to acquire more comprehensive blockchain information from multiple channels.

By such a method, user credit information stored by each agency, bank and enterprise can be obtained from each blockchain node according to an inquiry request of an inquirer at any blockchain node, thereby facilitating each inquirer to obtain more complete user credit information, which improves the comprehensiveness and reliability of user evaluation, and can also expand application scenarios of the user credit information.

In some embodiments, after receiving a data inquiry request, the blockchain node can inquire its own stored blockchain data first, and if having obtained a credit information summary from each blockchain node with respect to the same data inquiry request within a predetermined time period before, directly feed the credit information summary back to the inquirer; otherwise, the blockchain node can inquire the user credit information in the manner of the embodiment shown in FIG. 2.

By such a method, sending a data inquiry request repeatedly in a network with respect to the same problem in a short time can be avoided, which on one hand, reduces the load of data processing of each blockchain node and the load of network data transmission, and on the other hand, reduces the load of data storage of each blockchain node, and can also improve information feedback speed and enhance user experience.

In some embodiments, if the credit information summary from each blockchain node with respect to the same data inquiry request has not been obtained within the predetermined time period, the inquiry can be performed again, thereby making the fed back user credit information be updated in time.

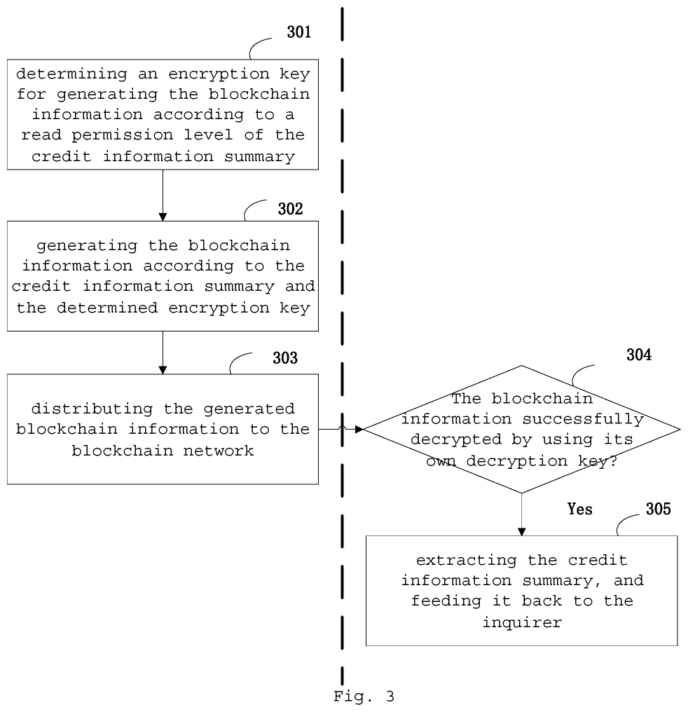

In some embodiments, in order to further improve the security of the user credit information, different permission levels can be set for different blockchain nodes, and only blockchain nodes meeting a read permission level can read the credit information summary in the blockchain information during blockchain information interaction. A flow diagram of a portion of a blockchain-based information interaction method according to other embodiments of the present disclosure is shown in FIG. 3, where in a single interaction, steps on the left and right sides of a dotted line are performed by different blockchain nodes, respectively.

In step 301, an encryption key for generating the blockchain information is determined according to a read permission level of the credit information summary.

In some embodiments, each blockchain node can store encryption keys respective levels of which are not higher than its own permission level, or can store only the encryption key meeting its own permission level.

In some embodiments, in order to encourage each party to actively provide its own data, its read permission level can be set according to the ability of the party and capability of data provided by blockchain node of the party, and the read permission level will be increased with the increase of the amount and importance of credit information summaries it provided.

In step 302, the blockchain node generates the blockchain information according to the credit information summary and the determined encryption key. In some embodiments, the blockchain node can encrypt using a key with a corresponding level according to the read permission level of the user credit information summary. In other embodiments, the block node can store only an encryption key meeting its own permission level, and encrypt its own generated credit information summary, thereby allowing only other blockchain nodes with a level that is not lower than the block node's own permission level to decrypt and read this credit information summary.

In step 303, the blockchain node distributes the generated blockchain information to the blockchain network, so that all nodes on the blockchain network obtain this blockchain information. In some embodiments, each node that receives the blockchain information can store this blockchain information, so as to enrich its own stored blockchain data.

In step 304, each blockchain node receiving the blockchain information determines whether the blockchain information can be successfully decrypted by using its own decryption key. In some embodiments, the blockchain node can store the decryption keys that are not higher than its own read permission level. If the decryption is successful, this blockchain node meets the read permission level requirement of the user credit information summary in the blockchain information, and step 305 is performed. If the decryption is not successful, the credit information summary in the blockchain information is not read, and in some embodiments, a prompt of inadequate permission can be provided to the inquirer.

In step 305, the credit information summary in the blockchain information is extracted, and fed back to the inquirer.

By such a method, data security can be ensured through encryption, while the setting of read permission levels can facilitate the realization of value added services while further improving the data security. For example, each blockchain node, when requesting data, needs to pay a certain fee for requesting the read permission, and each party, when providing the data, can also obtain a certain fee, to provide paid data services, thereby facilitating each party to actively provide its own data.

In some embodiments, it can further be set that the newer the data, the higher the price, and data which is generated a longer time ago than a predetermined time period can be provided relatively cheaply or freely, so that in view of the possibility of information diffusion and propagation over time, information timeliness is effectively utilized to provide benefits for information providers, which facilitates popularization and application.

In some embodiments, a whitelist can be set to control the permission of each node accessing a blockchain network, and data provided by a non-whitelist blockchain node is audited for security, which ensures the authenticity and validity of the data and the reliability of the provided credit information.

A schematic diagram of a blockchain node according to some embodiments of the present disclosure is shown in FIG. 4. A summary generation unit 401 can generate a credit information summary from user data. In some embodiments, a blockchain node can be a blockchain node of a government agency, capable of acquiring the user data stored by the corresponding government agency; the blockchain node can be a blockchain node of a bank, capable of acquiring the user data stored by the corresponding bank; the blockchain node can also be a blockchain node of an enterprise, capable of acquiring blockchain data stored by a corresponding enterprise. The blockchain node generates the credit information summary according to its own acquired user information.

A blockchain information generation unit 402 can generate blockchain information according to the credit information summary.

A blockchain information interaction unit 403 can distribute the blockchain information on a blockchain network and receive blockchain information from other nodes of the blockchain network, so as to perform interaction of the user credit information summary among different nodes through the blockchain network.

Such a blockchain node can generate a credit information summary according to the acquired user data, and distribute it as the blockchain information on a blockchain network; and can receive the blockchain information from other blockchain nodes, thereby achieving user credit information interaction based on the blockchain network, which improves the comprehensiveness of personal credit information obtained from each node.

In some embodiments, the blockchain node can comprise a request receiving unit 405 and a feedback unit 408. The request receiving unit 405 is capable of receiving a data inquiry request from an inquirer. In some embodiments, the data inquiry request can include a name, identification number of the inquired user, or other information that facilitates identification of this user. In other embodiments, the data inquiry request can include a user filtering requirement, such as a requirement for one or more credits, so as to filter out a user meeting this requirement.

The summary generation unit 401 can inquire the stored user data according to inquiry requirements in the data inquiry request, and generate the credit information summary.

The blockchain information generation unit 402 can generate the blockchain information according to the data inquiry request and distribute it to the blockchain network by the blockchain information interaction unit 403. In some embodiments, the blockchain information generation unit 402 can also generate the blockchain information from the credit information summary generated by the summary generation unit 402, and distribute it to the network by the blockchain information interaction unit 403.

If the blockchain information received by the blockchain information interaction unit 403 includes a data inquiry request, then the summary generation unit 401 can generate the credit information summary according to the user data and the data inquiry request, and the blockchain information generation unit 402 can generate the blockchain information according to the data inquiry request and distribute it to the blockchain network by the blockchain information interaction unit 403.

The feedback unit 408 can feed the credit information summary generated by the summary generation unit 401 and the credit information summary in the blockchain information received by the blockchain information interaction unit 403 back to the inquirer issuing the data inquiry request.

Such a blockchain node can obtain user credit information stored by each agency, bank and enterprise from each blockchain node according to an inquiry request of an inquirer at any blockchain node, thereby facilitating each inquirer to conveniently obtain more complete user credit information, which expands application scenarios of the user credit information while improving the comprehensiveness and reliability of user evaluation.

In some embodiments, after receiving the data inquiry request, the request receiving unit 405 can inquire its own stored blockchain data first, and if having obtained a credit information summary from each blockchain node with respect to the same data inquiry request within a predetermined time period before, directly feeds the credit information summary back to the inquirer; otherwise, can inquire user credit information in the manner of the embodiment shown in FIG. 2.

Such a blockchain node can avoid repeatedly sending a data inquiry request in a network with respect to the same problem in a short time, which on the one hand, reduces the load of data processing of each blockchain node and the load of network data transmission, and on the other hand, reduces the load of data storage of each blockchain node, and can also improve information feedback speed. If the credit information summary from each blockchain node with respect to the same data inquiry request has been obtained before the predetermined time period, the inquiry can be performed again, thereby making the fed back user credit information be updated in time.

In some embodiments, as shown in FIG. 4, the blockchain node can further comprise a key determination unit 406 and a decryption unit 407. The key determination unit 406 is capable of determining an encryption key for generating the blockchain information according to a read permission level of the credit information summary. The blockchain information generation unit 402 generates the blockchain information according to the credit information summary and the determined encryption key.

In the case that blockchain information received by the blockchain information interaction unit 403 includes a data inquiry request, the decryption unit 407 determines whether the blockchain information can be successfully decrypted by using owned decryption key. If the decryption is successful, the credit information summary in the blockchain information is extracted, and is fed back to the inquirer by the feedback unit 408; and if the decryption fails, the credit information summary in this blockchain information is ignored. In some embodiments, in the case that the decryption fails, the blockchain node can only store but not read this blockchain information.

Such a device can ensure data security through encryption, while the setting of read permission levels can also facilitate the realization of value added services while further improving the data security. For example, each blockchain node, when requesting data, needs to pay a certain fee for requesting read permission, and each party, when providing the data, can also obtain a certain fee, to provide paid data services, thereby facilitates each party to actively provide its own data.

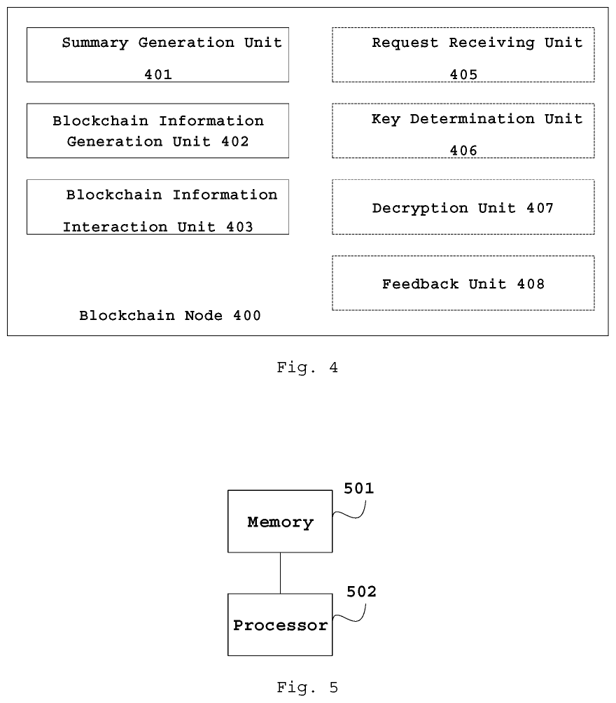

A schematic structural diagram of a blockchain node according to some embodiments of the present disclose is shown in FIG. 5. A blockchain node device comprises a memory 501 and a processor 502. The memory 501 herein may be a magnetic disk, flash memory, or any other non-volatile storage medium. The memory is configured to store instructions in the embodiments corresponding to the above blockchain-based information interaction methods. Coupled to the memory 501 is the processor 502, which can be implemented as one or more integrated circuits, such as a microprocessor or microcontroller. The processor 502 is configured to execute the instructions stored in the memory, and is capable of realizing user credit information interaction based on a blockchain network, thereby improving the comprehensiveness of personal credit information obtained from each node.

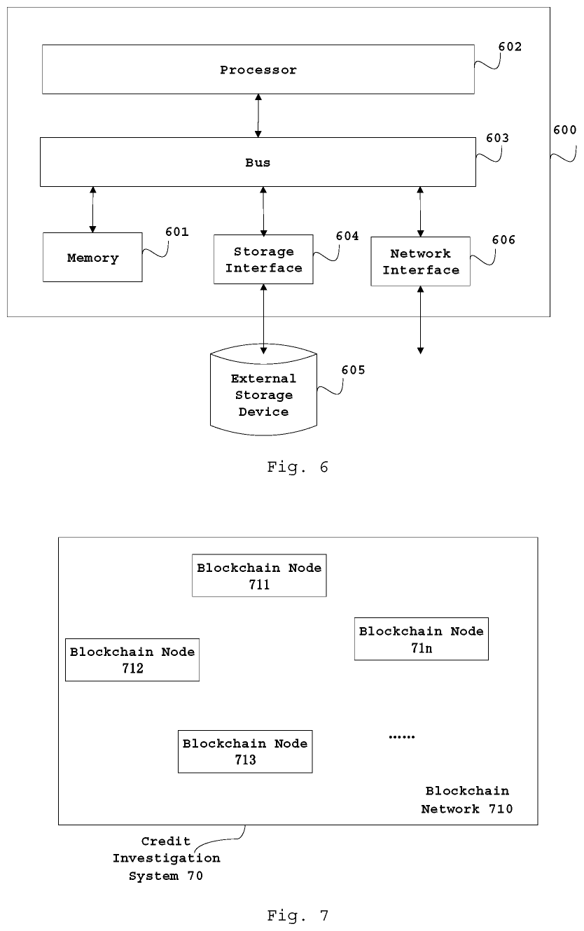

In some embodiments, as also shown in FIG. 6, the blockchain node 600 comprises a memory 601 and a processor 602. The processor 602 is coupled to the memory 601 through a BUS 603. This blockchain node 600 can also be connected to an external storage device 605 through a storage interface 604, so as to call external data, and can also be connected to a network or another computer system (not shown) through a network interface 606. It will not be described in detail herein.

In this embodiment, by means of the data instructions stored in the memory and then processed by the processor, user credit information interaction based on the blockchain network can be realized, thereby improving the comprehensiveness of personal credit information obtained from each node.

In other embodiments, a computer-readable storage medium has stored thereon computer program instructions which, when executed by a processor, implement the steps of the method in the embodiments corresponding to the blockchain-based information interaction methods. As will be appreciated by those skilled in the art, the embodiments of the present disclosure can be provided as a method, apparatus, or computer program product. Accordingly, the present disclosure can take the form of an entirely hardware embodiment, an entirely software embodiment or an embodiment combining software and hardware aspects. Furthermore, the present disclosure can take the form of a computer program product implemented on one or more computer-usable non-transitory storage media (including, but not limited to, disk storage, CD-ROM, optical storage, and so forth) having computer-usable program codes embodied therein.

A schematic diagram of a credit investigation system 70 according to some embodiments of the present disclosure is shown in FIG. 7. Blockchain nodes 711 to 71n can be any of the blockchain nodes described above, and form a blockchain network 710 through network links. In some embodiments, the network link can be any internet link capable of carrying interaction between blockchain nodes. In some embodiments, the network link can be a Mesh Networking link. Each of the blockchain nodes 711 to 71n can be a government agency blockchain node, a bank blockchain node, or an enterprise blockchain node of any enterprise. The government agency blockchain node is capable of generating the credit information summary according to at least one of user's assets, social relations and payment records recorded by the government agency. The bank blockchain node is capable of generating the credit information summary based on at least one of user's income, statements, properties, or loan records recorded by a bank. The enterprise blockchain node is capable of generating the credit information summary according to user's behavior records on the enterprise platform.

In such a credit investigation system, each blockchain node can generate a credit information summary according to acquired user data, and distribute it as the blockchain information on a blockchain network; and can receive blockchain information from other blockchain nodes, thereby realizing user credit information interaction based on the blockchain network, which improves the comprehensiveness of personal credit information obtained from each node.

The present disclosure is described with reference to flow diagrams and/or block diagrams of the methods, apparatuses (systems) and computer program products according to the embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions can be provided to a processor of a general purpose computer, special purpose computer, embedded processor, or other programmable data processing apparatus to produce a machine, such that through the instructions, which are executed by the processor of the computer or other programmable data processing apparatus, a means for implementing the functions specified in one or more flows in the flow diagrams and/or one or more blocks in the block diagrams is created.

These computer program instructions can also be stored in a computer-readable memory that can direct a computer or other programmable data processing apparatus to function in a particular manner, such that the instructions stored in this computer-readable memory produce an article of manufacture including instruction means which implement the functions specified in one or more flows in the flow diagrams and/or one or more blocks in the block diagrams.

These computer program instructions can also be loaded onto a computer or other programmable data processing apparatus, such that a series of operational steps are performed on the computer or other programmable apparatus to produce a process implemented by the computer, and thus, the instructions, which are executed on the computer or other programmable apparatus, provide the steps for implementing the functions specified in one or more flows in the flow diagrams and/or one or more blocks in the block diagrams.

Thus far, the present disclosure has been described in detail. Some details well known in the art have not been described in order to avoid obscuring the concepts of the present disclosure. Those skilled in the art can now fully appreciate how to implement the technical solution disclosed herein, in view of the foregoing descriptions.

The methods and apparatus of the present disclosure can be implemented in a number of ways. For example, the methods and apparatus of the present disclosure can be implemented by software, hardware, firmware, or any combination of software, hardware, and firmware. The above-described order for the steps of the methods is for illustration only, and the steps of the methods of the present disclosure are not limited to the order specifically described above unless specifically stated otherwise. Further, in some embodiments, the present disclosure can also be implemented as programs recorded in a recording medium, and these programs include machine-readable instructions for implementing the methods according to the present disclosure. Thus, the present disclosure also covers the recording medium storing the programs for performing the methods according to the present disclosure.

Finally, it should be noted that: the above embodiments are intended only to illustrate the technical solution of the present disclosure and not to limit it; although the present disclosure has been described in detail with reference to the preferred embodiments, those of ordinary skill in the art will understand that: modifications to the specific embodiments of the present disclosure or equivalent substitutions for parts of the technical features can be made, all of which are intended to be covered by the scope of the claims of this disclosure without departing from the spirit thereof.

1: A blockchain-based information interaction method, comprising:
generating, by a blockchain node, a credit information summary according to user data;
generating blockchain information according to the credit information summary; and
distributing the blockchain information on a blockchain network, to perform interaction of credit information summary from different nodes through the blockchain network.

2: The information interaction method according to claim 1, wherein the generating, by a blockchain node, a credit information summary according to user data comprises:
generating the credit information summary according to at least one of user's assets, social relations and payment records recorded by a government agency;
generating the credit information summary according to at least one of user's income, statements, properties, or loan records recorded by a bank; or
generating the credit information summary according to user's behavior records on an enterprise platform.

3: The information interaction method according to claim 2, wherein the generating the credit information summary according to user's behavior records on an enterprise platform comprises:
generating the credit information summary according to one or more of user's chat records on a social software, transaction records on a payment platform, consumption records on a shopping platform, or travel records on a travel or map platform.

4: The information interaction method according to claim 1, further comprising:
receiving a data inquiry request; and
generating the blockchain information according to the data inquiry request and distributing the blockchain information on the blockchain network, to generate the credit information summary by each blockchain node according to the data inquiry request.

5: The information interaction method according to claim 1, further comprising:
in the case that a data inquiry request is comprised in received blockchain information, or the data inquiry request is received from an inquirer, inquiring stored user data according to inquiry requirements in the data inquiry request, then generating the credit information summary, and generating the blockchain information and distributing to the blockchain network,
wherein the blockchain information comprising the data inquiry request is generated and distributed to the blockchain network by a blockchain node receiving the data inquiry request from the inquirer.

6: The information interaction method according to claim 1, further comprising:
determining an encryption key according to a read permission level of the credit information summary; and
generating encrypted blockchain information according to the credit information summary and the encryption key, to allow a blockchain node that meets the read permission level requirement to resolve the encrypted blockchain information and prevent a blockchain node that does not meet the read permission level requirement from resolving the encrypted blockchain information.

7: The information interaction method according to claim 1, further comprising:
storing received blockchain information, and decrypting the received blockchain information by using a decryption key of a blockchain node which receives the blockchain information, wherein the received blockchain information is generated by encryption with the use of the encryption key determined according to the read permission level of the credit information summary.

8-14. (canceled)

15: A blockchain node, comprising:
a memory; and
a processor coupled to the memory, which, based on instructions stored in the memory, is configured to perform a method comprising:
generating a credit information summary according to user data;
generating blockchain information according to the credit information summary; and
distributing the blockchain information on a blockchain network, to perform interaction of credit information summary from different nodes through the blockchain network.

16: A non-transitory computer-readable storage medium having stored thereon computer program instructions, wherein the instructions, when executed by a processor, implement a method for performing operations comprising:
generating, by a blockchain node, a credit information summary according to user data;
generating blockchain information according to the credit information summary; and
distributing the blockchain information on a blockchain network, to perform interaction of credit information summary from different nodes through the blockchain network.

17: A credit investigation system, comprising:
a plurality of blockchain nodes according to claim 15; and
a network link, configured to act as an carrier for carrying interaction between the blockchain nodes.

18: The system according to claim 17, wherein the blockchain node comprises at least one of:
a government agency blockchain node, configured to generate the credit information summary according to at least one of user's assets, social relations and payment records recorded by a government agency;
a bank blockchain node, configured to generate the credit information summary based on at least one of user's income, statements, properties, or loan records recorded by a bank; or
an enterprise blockchain node, configured to generate the credit information summary according to user's behavior records on an enterprise platform.

19: The information interaction method according to claim 5, further comprising:
storing received blockchain information, and decrypting the received blockchain information by using a decryption key of a blockchain node which receive the blockchain information, wherein the received blockchain information is generated by encryption with the use of the encryption key determined according to the read permission level of the credit information summary; and
in the case the decryption is successful, extracting the credit information summary and feeding back to the inquirer; and
in the case that the decryption fails, feeding inadequate permission back to the inquirer.

20: The blockchain node according to claim 15, wherein the method further comprising:
receiving a data inquiry request; and
generating the blockchain information according to the data inquiry request and distributing the blockchain information on the blockchain network, to generate the credit information summary by each blockchain node according to the data inquiry request.

21: The blockchain node according to claim 15, wherein the method further comprising:
in the case that a data inquiry request is comprised in received blockchain information, or the data inquiry request is received from an inquirer, inquiring stored user data according to inquiry requirements in the data inquiry request, then generating the credit information summary, and generating the blockchain information and distributing to the blockchain network,
wherein the blockchain information comprising the data inquiry request is generated and distributed to the blockchain network by a blockchain node receiving the data inquiry request from the inquirer.

22: The blockchain node according to claim 15, wherein the method further comprising:
determining an encryption key according to a read permission level of the credit information summary; and
generating encrypted blockchain information according to the credit information summary and the encryption key, to allow a blockchain node that meets the read permission level requirement to resolve the encrypted blockchain information and prevent a blockchain node that does not meet the read permission level requirement from resolving the encrypted blockchain information.

23: The blockchain node according to claim 21, wherein the method further comprising:
storing received blockchain information, and decrypting the received blockchain information by using a decryption key of a blockchain node which receive the blockchain information, wherein the received blockchain information is generated by encryption with the use of the encryption key determined according to the read permission level of the credit information summary; and
in the case the decryption is successful, extracting the credit information summary and feeding back to the inquirer; and
in the case that the decryption fails, feeding inadequate permission back to the inquirer.

24: The non-transitory computer-readable storage medium according to claim 16, wherein the method further comprising:
receiving a data inquiry request; and
generating the blockchain information according to the data inquiry request and distributing the blockchain information on the blockchain network, to generate the credit information summary by each blockchain node according to the data inquiry request.

25: The non-transitory computer-readable storage medium according to claim 16, wherein the method further comprising:
in the case that a data inquiry request is comprised in received blockchain information, or the data inquiry request is received from an inquirer, inquiring stored user data according to inquiry requirements in the data inquiry request, then generating the credit information summary, and generating the blockchain information and distributing to the blockchain network,
wherein the blockchain information comprising the data inquiry request is generated and distributed to the blockchain network by a blockchain node receiving the data inquiry request from the inquirer.

26: The non-transitory computer-readable storage medium according to claim 16, wherein the method further comprising:
determining an encryption key according to a read permission level of the credit information summary; and
generating encrypted blockchain information according to the credit information summary and the encryption key, to allow a blockchain node that meets the read permission level requirement to resolve the encrypted blockchain information and prevent a blockchain node that does not meet the read permission level requirement from resolving the encrypted blockchain information.

27: The non-transitory computer-readable storage medium according to claim 25, wherein the method further comprising:
storing received blockchain information, and decrypting the received blockchain information by using a decryption key of a blockchain node which receive the blockchain information, wherein the received blockchain information is generated by encryption with the use of the encryption key determined according to the read permission level of the credit information summary; and
in the case the decryption is successful, extracting the credit information summary and feeding back to the inquirer; and
in the case that the decryption fails, feeding inadequate permission back to the inquirer.
